(19) United States
(12) Patent Application Publication
(10) Pub. No.: US 2012/0228264 A1
(43) Pub. Date: Sep. 13, 2012

(54) USE OF SPECIFIC COMPOSITE MATERIALS AS ELECTRIC ARC EXTINCTION MATERIALS IN ELECTRICAL EQUIPMENT

(75) Inventor: Daniel Piccoz, Lucenay (FR)

(73) Assignee: SCHNEIDER ELECTRIC ENERGY FRANCE, Rueil Malmaison (FR)

(21) Appl. No.: 13/505,645

(22) PCT Filed: Nov. 3, 2010
(86) PCT No.: PCT/EP10/66740

§ 371 Date: May 2, 2012

(30) Foreign Application Priority Data
Nov. 3, 2009 (FR) 09 57767

(51) Int. Cl. H01H 9/30; C08L 27/12; C08K 3/16

(52) U.S. Cl. 218/85; 524/403; 218/150

(57) ABSTRACT

The present invention provides the use of a composite material comprising a polymeric matrix and at least one metal fluoride filler selected from the cerium fluorides CeF₃ and/or CeF₄, lanthanum fluoride LaF₃ and mixtures thereof, as an electric arc extinction material in electrical equipment.

### TECHNICAL FIELD

The present invention relates to composite materials comprising a polymeric matrix that may be a fluorinated polymer matrix and a specific metal fluoride filler used as electric arc extinction materials.

Such materials may be of application in electrical equipment where electric arcs may appear, such as switchgear, for example, in medium voltage or high voltage switches or medium voltage or high voltage switch disconnectors.

Thus, the general field of the invention is that of electric arcs and means for extinguishing them.

### PRIOR ART

An electric arc is a visible electric current in a generally insulating medium, that is created between two conductive surfaces that are close to each other, providing the potential difference between said two surfaces is sufficient.

That electric current is manifested by ionization of a generally insulating medium through which it passes, thereby constituting neither more nor less than a plasma that may reach temperatures that are high, for example a temperature of 2000 (K) to 10,000 K.

When it strikes, an electric arc may cause degradation of the surrounding elements as well as large electromagnetic disturbances, which may prove to be a problem in electrical equipment and in particular in electrical equipment intended to interrupt a current, such as circuit breakers, switches, or switch disconnectors.

That type of equipment that is intended to interrupt current functions on the principle of separating contacts. After said contacts have separated, the current continues to flow in the circuit via an electric arc that is established between the ends of said separated contacts. In order to interrupt the current and also to prevent the electric arc that is produced thereby from degrading the equipment, various electric arc extinction means have been developed; examples that may be mentioned are:

extinction by the presence of an electric arc extinction gas in the zone in which the electric arc is produced;

extinction by the presence of an electric arc extinction liquid in the zone in which the electric arc is produced; and

extinction by placing the zone in which the electric arc is produced under vacuum.

The principle of electric arc extinction using extinction gases lies in the intrinsic qualities of the gases used; preferably, they must have the following qualities:

the capacity to transport the heat energy produced by the arc in order to allow rapid outward exchanges of heat from the core of the arc;

the capacity to capture the principal electrons responsible for electrical conduction in the gas;

reversible decomposition of its molecules, so that the quantity of operational gas in the equipment remains constant, thereby avoiding any need to re-fill the equipment with the gas throughout its service life.

An effective candidate for an electric arc extinction gas is sulfur hexafluoride SF₆, which has a high thermal conductivity and constitutes a genuine electron trap. Those qualities mean that the gas is used in many types of switchgear, in particular in equipment of the switch disconnector type, where the gas surrounding the electric arcing contacts is stored in cells that are narrow (for example 375 mm for a cutoff voltage of 24 kV. However, that gas suffers from an environmental drawback, since it generates a recognized greenhouse effect. In order to comply with regulations that are in force, its use must therefore be managed very rigorously from its manufacture to the end of its life and also during recycling thereof.

In order to overcome this problem, several gases have been used to replace sulfur hexafluoride SF₆; they include ambient air, nitrogen N₂, and carbon dioxide. However, because of their poorer extinction capacities compared with sulfur hexafluoride SF₆, cells including such gases, and in particular ambient air, must be bulkier (for example, cells with a width of 600 mm to 700 mm for a cutoff voltage of 24 kV).

As mentioned above, electric arc extinction may be ensured by liquids, in particular by oils. From a structural viewpoint, the arcing contacts between which the electric arc is formed during separation thereof are contained in oil placed in a metal tank or, in another mode, they may be sprayed by blowing vaporized oil. Under the action of the electric arc, the oil decomposes into a gas (essentially hydrogen and acetylene), and so the energy of the arc used for such decomposition brings about cooling of the medium.

However, that interruption technique suffers from the major disadvantage of requiring regular operations for replacing the spent oil, since decomposition thereof by the electric arcs is irreversible. Further, the formation of hydrogen must be very carefully monitored since an explosive mixture may be formed when hydrogen comes into contact with oxygen.

Finally, extinction of the electric arc established between two arcing contacts may be ensured by creating a vacuum atmosphere between the contacts; a vacuum is a very good insulator. However, that extinction technique is complex in implementation since it requires placing a vacuum bottle in series with the cell including said arcing contacts.

The inventors thus aimed to develop novel electric arc extinction means that, in addition to gas type electric arc extinction means, can improve the extinction performances of switchgear, in particular medium voltage switchgear.

One of the aims of the invention is to develop novel electric arc extinction means that mean that the use of sulfur hexafluoride SF₆ as an extinction gas can be dispensed with.

The inventors thus surprisingly discovered that, by using the composite materials comprising specific inorganic fillers, it is possible to obtain better results in terms of electric arc extinction than the use of composite materials comprising inorganic fillers, such as magnesium fluoride or barium fluoride.

### DISCLOSURE OF THE INVENTION

Thus, the invention provides the use of a composite material comprising a polymeric matrix and at least one metal fluoride filler selected from the cerium fluorides CeF₃ and/or CeF₄, lanthanum fluoride LaF₃ and mixtures thereof, as an electric arc extinction material in electrical equipment.

These materials provide excellent results as regards electric arc extinction in switchgear, in particular medium voltage switchgear (namely equipment that conventionally functions at voltages in the range 1 kV to several tens of kilovolts, for example voltages in the range 1 kV to 52 kV).

The materials used in accordance with the invention advantageously include a fluorinated polymeric matrix, i.e. a polymer including fluorine atoms.

Fluorinated polymers that are suitable for the present invention may be polytetrafluoroethylene (abbreviated to PTFE), a tetrafluoroethylene-tetrafluoropropylene copolymer (abbreviated to FEP), or a tetrafluoroethylene-perfluorinated vinyl ether copolymer (abbreviated to PFA).

As mentioned above, metal fluoride type fillers selected from the cerium fluorides CeF₃ and/or CeF₄, lanthanum fluoride LaF₃ and mixtures thereof may be dispersed in the polymeric matrix as defined above, in an amount that may be from 2% to 35% by weight relative to the total weight of the composite material, for example 5% by weight relative to the total weight of the composite material.

From a functional viewpoint, in contact with an electric arc, the materials as defined above release insulating electronegative atoms, in this example fluorine atoms, which atoms absorb a portion of the electric arc energy equal to the energy required for their liberation and thus contribute to extinction of the arc.

Because of their efficiency, these materials can be used in gaseous environments that include extinction gases that are less efficient than sulfur hexafluoride SF₆ but that are less environmentally damaging, as with carbon dioxide, CO₂.

Specific materials that may be used in accordance with the invention are:

a composite material comprising a PTFE matrix and 5% by weight of CeF₃ relative to the total weight of the material;

a composite material comprising a PTFE matrix and 5% by weight of CeF₄ relative to the total weight of the material; and

a composite material comprising a PTFE matrix and 5% by weight of LaF₃ relative to the total weight of the material.

A particularly advantageous material in accordance with the invention is a material comprising cerium trifluoride CeF₃ or cerium tetrafluoride CeF₄ as the metal fluoride filler, said fillers also having the capacity to absorb ultraviolet radiation emanating from the electric arc, said cerium trifluoride or said cerium tetrafluoride CeF₄ possibly being used in association with PTFE, FEP or PFA.

In addition to the fillers mentioned above, in a first variation, the material may include one or more fillers that absorb ultraviolet radiation (which is abbreviated to UV below) such as boron nitride BN, silicon dioxide SiO₂, alumina Al₂O₃, CoOAl₂O₃, titanium dioxide TiO₂, molybdenum sulfide MoS₂, cerium trifluoride CeF₃, cerium tetrafluoride CeF₄ (which is capable of being transformed into CeF₃ and of liberating fluorine F₂), and mixtures thereof.

In accordance with a second variation, the composite material defined above may be used in association with another composite material comprising a polymeric matrix, for example a polymer matrix formed from a fluorinated polymer and at least one filler that absorbs ultraviolet radiation, such as a filler comprising boron nitride BN, silicon dioxide SiO₂, alumina Al₂O₃, CoOAl₂O₃, titanium dioxide TiO₂, molybdenum sulfide MoS₂, cerium trifluoride CeF₃, cerium tetrafluoride CeF₄, and mixtures thereof.

Thus, in this second variation, in the electrical equipment in which they are used, the two materials may be in the form of distinct parts, for example:

a part formed from composite material comprising a polymeric matrix, for example a fluorinated polymer matrix, and at least one metal fluoride filler selected from the fluorides of cerium CeF₃ and/or CeF₄, lanthanum fluoride LaF₃ and mixtures thereof located, for example, at the foot of the electric arc in the form, for example, of a washer surrounding one of the arcing contacts of the equipment;

a part formed from composite material comprising a polymeric matrix, for example a fluorinated polymer matrix, and at least one filler that absorbs ultraviolet radiation located, for example, on the path of the electric arc.

The advantage of also using a filler that absorbs UV is that it can absorb the ultraviolet radiation emanating from the electric arc and can thus contribute to facilitating extinction thereof.

The materials mentioned above may be used in medium voltage or high voltage electrical equipment, in particular in switchgear such as circuit breakers, switches, or switch disconnectors.

In particular, the materials mentioned above are adapted for use in switchgear units that also include an extinction gas other than sulfur hexafluoride SF₆, such as switchgear including carbon dioxide CO₂, nitrogen N₂, or mixtures thereof.

Thus, in a second aspect, the invention provides electrical equipment comprising at least one first arcing contact and at least one second arcing contact between which an electric arc is established during their separation and including, as electric arc extinction means, at least one material as defined above, said material further optionally including one or more fillers that absorb ultraviolet radiation as defined below or being optionally in association with another composite material comprising a polymer matrix, for example, a matrix in a fluorinated polymer, and at least one filler that absorbs ultraviolet radiation as defined above.

Said composite material including a metal fluoride type filler may be disposed at the foot of the arc, i.e. around at least one of said arcing contacts, for example in the form of a washer around at least one of the electric arcing contacts of the equipment mentioned above or in the form of a strip located on the path of the electric arc.

The equipment mentioned above may be switchgear such as a circuit breaker, a switch or a switch disconnector, said equipment possibly being medium voltage equipment.

The equipment may include an extinction gas, for example an extinction gas selected from carbon dioxide, nitrogen, and mixtures thereof. Advantageously, the extinction gas is free of sulfur hexafluoride, SF₆.

The invention is described below with reference to the implementations presented below, given by way of non-limiting illustration.

### BRIEF DESCRIPTION OF THE DRAWINGS

FIG. 1 is a diagrammatic representation of switchgear in accordance with a first embodiment.

FIG. 2 is a detailed view of the switchgear shown in FIG. 1.

FIG. 3 is a diagrammatic representation of switchgear in accordance with a second embodiment.

### DETAILED DESCRIPTION OF PARTICULAR EMBODIMENTS

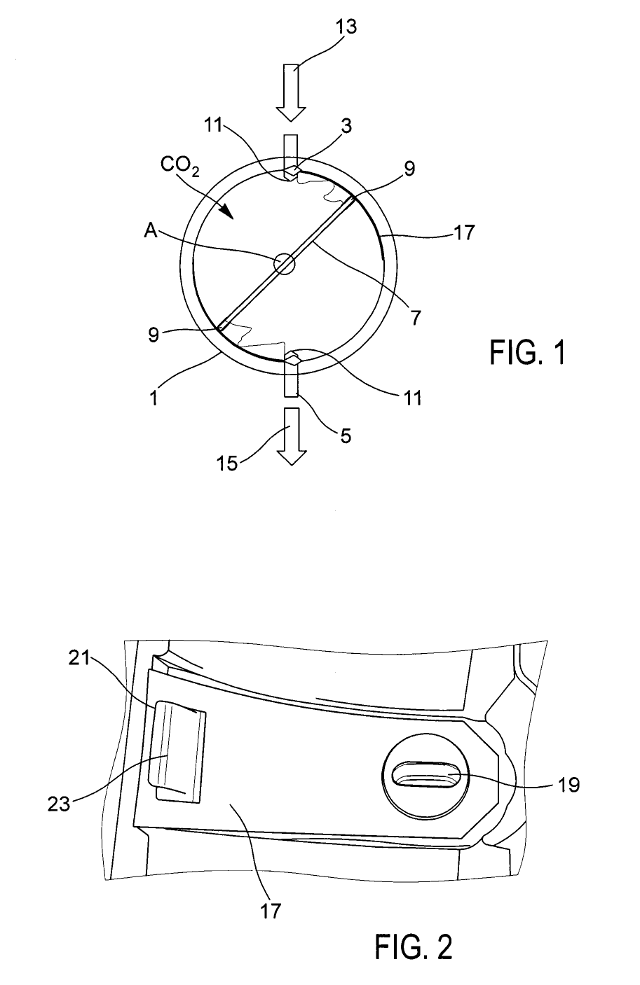

FIG. 1 shows an insulating chamber 1 that has two diametrically-opposite stationary contacts 3, 5 at its margin and that contains a movable contact 7 that is pivotally mounted about an axis A in a manner that is concentric relative to the insulating chamber 1.

The movable contact 7 is in the form of a rod of length that is very slightly shorter than the inside diameter of the insulating chamber 1, with ends that can come into contact simultaneously with the ends 11 of the stationary contacts 3, 5 penetrating into the inside of the insulating chamber 1.

The current supply is symbolized by a first arrow 13 at a first stationary contact 3; the outgoing current is symbolized by a second arrow 15 leaving the other stationary contact 5 diametrically opposite to the first.

A washer (not shown in FIG. 1) is positioned around the end 11 of each stationary contact 3, 5; it is formed from a composite material that is in accordance with the invention, namely a material comprising a polymeric matrix, advantageously a fluorinated polymer matrix, and one or more fillers of the metal fluoride type selected from the cerium fluorides CeF₃ and/or CeF₄, lanthanum fluoride LaF₃ and mixtures thereof. The washer is located at the inside wall of the insulating chamber 1, such that the end 11 of each stationary contact 3, 5 can penetrate into the inside of the insulating chamber 1. Each washer may be surrounded by a strip formed from a composite material comprising a polymeric matrix, advantageously a fluorinated polymer matrix, and one or more fillers that absorb ultraviolet radiation (for example boron nitride BN, silicon dioxide SiO₂, alumina Al₂O₃, CoOAl₂O₃, titanium dioxide TiO₂, molybdenum sulfide MoS₂, cerium trifluoride CeF₃, cerium tetrafluoride CeF₄, and mixtures thereof), said strip being in the form of a circular arc that is flush against the inside surface of the insulating chamber 1; one end of it encompasses the disk. The shape of this strip corresponds to the movement of one of the ends 9 of the movable contact 7, which is rotatably mounted about the central axis A.

It should be understood that the other end 9 may also be provided with a washer.

The empty space between the insulating chamber and the movable contact is occupied by a gas such as carbon dioxide, CO₂.

As the movable contact starts to rotate (resulting in mechanical separation of the ends of the movable contact and the stationary contacts), an electric arc is generated between the ends 11 of the stationary contacts 3, 5 and the ends 9 of the movable contact 7. Because of the electric arc, each washer, located at the foot of the arc, is partially sublimated, thereby releasing highly electronegative insulating elements (in particular, fluorine atoms), that absorb the ions present in the plasma constituting the electric arc (such as ions from the contact materials and the surrounding gas), which contributes to cooling the plasma and thus to decay of the electric arc.

Because of their constitution, the above-mentioned strips can absorb a portion of the ultraviolet radiation emanating from the plasma (and thus a portion of its energy) and thereby contribute to extinction of the electric arc in collaboration with the material of the washer.

Tests in the presence of a carbon dioxide gas CO₂ have revealed manifest effectiveness with regard to the amperage of the current.

Thus, by way of example, with a Fluokit switch type electric device comprising a PTFE protection strip filled with 5% by weight of cerium trifluoride CeF₃, it is possible to interrupt electric currents of 630 A at 12 kV with a CO₂ pressure of 1.3 bar relative, the mean arc time being 7.6 ms, whereas the same assay with a PTFE protection strip filled with 5% by weight of magnesium fluoride MgF₂ led to a particularly higher mean arc time (being 13.6 ms), proving the higher efficiency of CeF₃ over MgF₂.

On the other hand, with a Fluokit switch type electric device comprising a PTFE protection strip filled with 5% by weight of cerium trifluoride CeF₃, it is possible to interrupt electric currents of 645 A at 24 kV with a CO₂/fluoroketone pressure of 1 bar relative, the mean arc time being 8.9 ms, whereas an assay with a PTFE protection strip filled with 5% by weight of magnesium fluoride MgF₂ with electric currents of 320 A at 24 kV led to a higher mean arc time (being 9.7 ms), proving once again the higher efficiency of CeF₃ over MgF₂.

FIG. 2 shows the assembly formed by the washer and the strip mentioned in FIG. 1, the reference numeral of the strip being 17 and the reference numeral of the associated washer being 19. A fixing tab 21 can be seen that projects into the inside of the insulating chamber 1 and that penetrates into the cavity 23 of the strip 17.

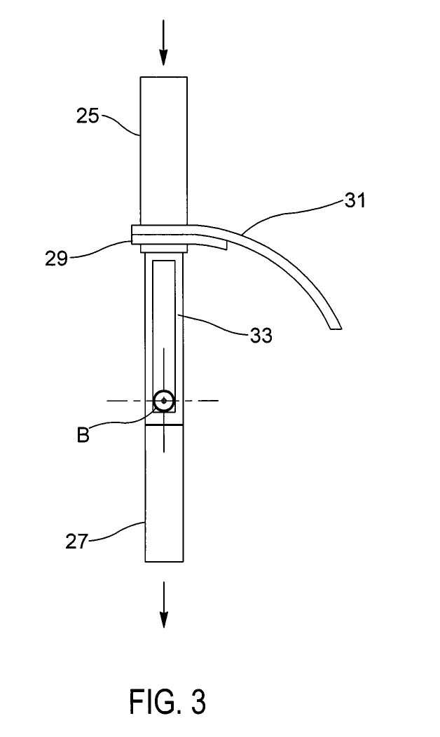

Referring now to FIG. 3, electrical equipment can be seen that includes a material in accordance with the invention, said equipment comprising two stationary contacts 25, 27 that are face to face and separated by a predetermined distance. A washer 29 formed from a material similar to that described for the washer of the preceding embodiment is placed around one end of the contact and an inwardly curved strip 31 is placed adjacent to the washer, said strip being formed from a material that is similar to that of the strip described for the above embodiment. The diameter of this strip 31 is equal to the length of the movable contact 33, which itself is pivotally mounted about an axis of rotation B placed on or in contact with a first stationary contact 27. Thus, the contact that is pivotally movable can be separated from the second stationary contact 25, its distal end running along the inner wall of the strip 31.

When the movable contact 33 separates from the stationary contact 25, an electric arc is created between one end of the movable contact and one end of the stationary contact 25, the foot of the electric arc being in contact with the washer 29 and running around said strip 31, with the washer 29 and the strip 31 contributing to reducing the extinction time of said electric arc.

1. A composite material, comprising a polymeric matrix and at least one metal fluoride filler selected from the group consisting of CeF₃, CeF₄, LaF₃ and mixtures thereof.

2. The material according to claim 1, wherein the polymeric matrix is a fluorinated polymer matrix.

3. The material according to claim 2, wherein the fluorinated polymer matrix is selected from the group consisting of a polytetrafluoroethylene, a tetrafluoroethylene-tetrafluoropropylene copolymer, and a tetrafluoroethylene-perfluorinated vinyl ether copolymer.

4. The material according to claim 1, wherein the composite material comprises the metal fluoride filler in an amount in the range 2% to 35% by weight relative to the total weight of the composite material.

5. The material according to claim 1, wherein the metal fluoride filler is CeF₃.

6. The material according to claim 1, wherein the metal fluoride filler is CeF₄.

7. The material according to claim 1, wherein the composite material is selected from the group consisting of
a composite material comprising a PTFE matrix and 5% by weight of CeF₃ relative to the total weight of the material;
a composite material comprising a PTFE matrix and 5% by weight of CeF₄ relative to the total weight of the material; and
a composite material comprising a PTFE matrix and 5% by weight of LaF₃ relative to the total weight of the material.

8. The material according to claim 1, wherein the composite material further comprises a filler that absorbs ultraviolet radiation.

9. The material according to claim 1, further comprising a second composite material comprising a second polymeric matrix and a filler that absorbs ultraviolet radiation.

10. The material according to claim 8, wherein the filler is selected from the group consisting of BN, SiO₂, Al₂O₃, CoOAl₂O₃, TiO₂, MoS₂, CeF₃, CeF₄, and mixtures thereof.

11. An electrical device, comprising:
a first arcing contact and a second arcing contact, between which an electric arc is established during separation thereof; and
a composite material comprising a polymeric matrix and at least one metal fluoride filler selected from the group consisting of CeF₃, CeF₄, LaF₃ and mixtures thereof.

12. The device according to claim 11, wherein the composite material further comprises a filler that absorbs ultraviolet radiation or further comprises a second composite material comprising a second polymeric matrix and a filler that absorbs ultraviolet radiation.

13. The device according to claim 11, which is switchgear.

14. The device according to claim 11, which is a circuit breaker, a switch, or a switch disconnector.

15. The device according to claim 11, further comprising an extinction gas.

16. The device according to claim 15, wherein the extinction gas is carbon dioxide, nitrogen, or a mixture thereof.

17. The device according to claim 15, wherein the extinction gas is free of sulfur hexafluoride.

18. The material of claim 1, which is suitable as a electric arc extinction material in electrical equipment.

19. A method of electric arc extinction, the method comprising contacting the composite material of claim 1 with an electric arc.

20. The method of claim 19, wherein the polymeric matrix is a fluorinated polymer matrix.
